(19) United States
(12) Patent Application Publication
(10) Pub. No.: US 2022/0225351 A1
(43) Pub. Date: Jul. 14, 2022

(54) METHOD OF WIRELESS COMMUNICATION SYSTEM FOR ENHANCING QUALITY OF SERVICE

(71) Applicant: INSTITUTE FOR INFORMATION INDUSTRY, TAIPEI (TW)

(72) Inventor: Shu-Tsz LIU, TAIPEI (TW)

(21) Appl. No.: 17/454,613

(22) Filed: Nov. 11, 2021

Related U.S. Application Data
(60) Provisional application No. 63/136,651, filed on Jan. 13, 2021.

(51) Int. Cl. H04W 72/12; H04W 72/14; H04L 1/08

(52) U.S. Cl. CPC H04W 72/1236; H04L 1/08; H04W 72/14

(57) ABSTRACT

A method of a wireless communication system is disclosed. The method includes: triggering a service reliability procedure in response to a first network condition; and determining whether to perform a protocol layer quality of service (QoS) handling mechanism or a physical layer QoS handling mechanism to enhance QoS between a network and a mobile terminal depending on a QoS requirement.

### RELATED APPLICATIONS

This application claims priority to U.S. Provisional Application Ser. No. 63/136,651, filed Jan. 13, 2021, which is herein incorporated by reference.

### BACKGROUND

### Field of the Invention

The disclosure relates to wireless communication technology, and more particularly to a method of a wireless communication system for enhancing quality of service (QoS).

### Description of Related Art

5G New Radio (NR) is a recently developed radio access technology that supports high throughput and low latency as well as large capacity communications. For industrial applications adopting 5G NR technology, such as man-machine coexistence, automated production, and so on, different connection recovery times are required when a connection error occurs. In particular, some applications (e.g. motion control and on board control) in automation technology require shorter connection recovery times. Therefore, how to quickly recover connections for certain specific applications has become an important issue to ensure normal operations for the industrial applications.

### SUMMARY

The disclosure directs to a method for providing quality of service (QoS) in a wireless communication system. The method includes: triggering a service reliability procedure in response to a first network condition; and determining whether to perform a protocol layer QoS handling mechanism or a physical layer QoS handling mechanism to enhance QoS between a network and a mobile terminal depending on a QoS requirement.

In accordance with one or more embodiments of the disclosure, performing the protocol layer QoS handling mechanism includes: activating, at the mobile terminal, a radio link control (RLC) entity for a packet data convergence protocol (PDCP) duplication; and determining, by the mobile terminal, whether a configured grant (CG) resource allocated nearby the mobile terminal is available for use within the QoS requirement, and if yes, utilizing the CG resource to perform a PDCP retransmission or transmission; otherwise, sending an uplink (UL) grant message to the network to ask for a dynamic grant (DG) resource to perform a PDCP retransmission or transmission.

In accordance with one or more embodiments of the disclosure, performing the protocol layer QoS handling mechanism further includes: sending, by the network, a media access control (MAC) control element (CE) to the mobile terminal for activating the RLC entity in response to the first network condition.

In accordance with one or more embodiments of the disclosure, the method further includes: stopping, by the mobile terminal, the PDCP duplication in response to a second network condition.

In accordance with one or more embodiments of the disclosure, the method further includes: sending, by the network, a MAC CE to the mobile terminal for stopping the PDCP duplication in response to the second network condition.

In accordance with one or more embodiments of the disclosure, the network sends a radio resource control (RRC) message to the mobile terminal for deactivating the PDCP duplication in response to a third network condition.

In accordance with one or more embodiments of the disclosure, performing the physical layer QoS handling mechanism includes applying physical layer repetition to retransmit or transmit a data packet.

In accordance with one or more embodiments of the disclosure, the physical layer repetition includes at least one of CG physical uplink shared channel (PUSCH) repetition, DG PUSCH repetition or resource block (RB) repetition.

In accordance with one or more embodiments of the disclosure, performing the physical layer QoS handling mechanism includes modifying a modulation and coding scheme (MCS) indication to retransmit or transmit a data packet.

In accordance with one or more embodiments of the disclosure, performing the physical layer QoS handling mechanism includes performing Bandwidth Part (BWP) switching and/or beam sweeping on the mobile terminal and/or the network to retransmit or transmit a data packet.

In accordance with one or more embodiments of the disclosure, performing the physical layer QoS handling mechanism includes utilizing frequency hopping, multi-input multi-output (MIMO), non-orthogonal multiple access (NOMA), or uplink preemption to retransmit or transmit a data packet for high priority transmission.

In accordance with one or more embodiments of the disclosure, the MAC CE is extended based on CG/SPS configurations MAC CE or PDCP duplication MAC CE for indicating to support the QoS requirement.

In accordance with one or more embodiments of the disclosure, the method further includes: utilizing a MAC Protocol Data Unit (PDU) with an extended logical channel ID (eLCID) value for a Downlink Shared Channel (DL-SCH) or an uplink shared channel (UL-SCH) for supporting activation and deactivation of the service reliability procedure.

In accordance with one or more embodiments of the disclosure, the method further includes: setting a timer to handle packet transmissions and/or re-transmission during the service reliability procedure.

In accordance with one or more embodiments of the disclosure, the method further includes: setting a priority indicator to configure transmission priorities during the service reliability procedure.

In accordance with one or more embodiments of the disclosure, the method further includes: setting a periodicity value to handle packet transmissions during the service reliability procedure.

In accordance with one or more embodiments of the disclosure, the method further includes: configuring user equipment (UE) capability information to support the QoS requirement during the service reliability procedure.

In accordance with one or more embodiments of the disclosure, the method further includes: adjusting a transmission time interval (TTI), a periodicity or a priority, or enabling physical layer repetition and/or MCS for packet transmissions during the service reliability procedure.

In accordance with one or more embodiments of the disclosure, triggering the service reliability procedure includes: sending, from the mobile terminal, an RRC message to the network for indicating that the mobile terminal supports the QoS requirement; and adding or modifying, at the network, a resource allocation configuration to support the QoS requirement.

In accordance with one or more embodiments of the disclosure, the RRC message is an RRC setup message with UE capability information, an RRC resume message with UE capability information, an RRC reconfiguration message with UE capability information, an RRC UE capability information message or an RRC UL information transfer message.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a wireless communication system in accordance with some embodiments of the disclosure.

FIG. 2 illustratively shows an example of message transmissions from a source terminal to a target terminal through a network.

FIG. 3 is a flowchart illustrating a method of a wireless communication system for enhancing quality of service (QoS) in accordance with some embodiments of the disclosure.

FIG. 4 is a flowchart illustrating a method of an initial configuration at the mobile terminal for the service reliability procedure in accordance with some embodiments of the disclosure.

FIG. 5 is a flowchart illustrating a method of an initial configuration at the network for the service reliability procedure in accordance with some embodiments of the disclosure.

FIG. 6 is a flowchart illustrating a method of a network control based PDCP duplication procedure in accordance with some embodiments of the disclosure.

FIG. 7 is a flowchart illustrating a method of a UE control based packet data convergence protocol (PDCP) duplication procedure in accordance with some embodiments of the disclosure.

FIG. 8 is a block diagram of an apparatus in accordance with some embodiments of the disclosure.

### DETAILED DESCRIPTION

The detailed explanation of the disclosure is described as following. The described preferred embodiments are presented for purposes of illustrations and description, and they are not intended to limit the scope of the disclosure.

Terms used herein are only used to describe the specific embodiments, which are not used to limit the claims appended herewith. Unless limited otherwise, the term “a,” “an,” “one” or “the” of the single form may also represent the plural form.

It will be understood that, although the terms “first,” “second,” “third” . . . etc., may be used herein to describe various elements and/or components, these elements and/or components, should not be limited by these terms. These terms are only used to distinguish elements and/or components.

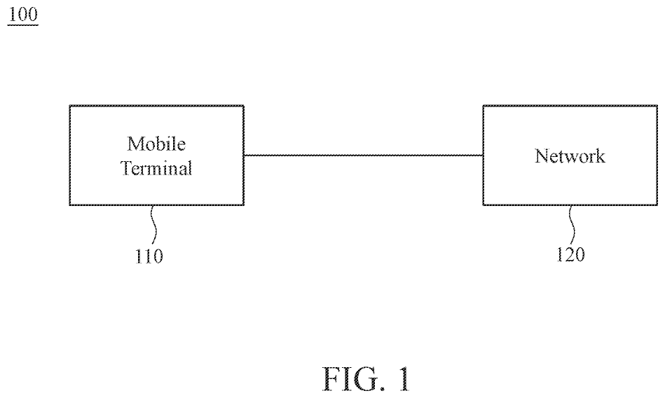

Referring to FIG. 1, which exemplarily illustrates a schematic diagram of a wireless communication system 100 in accordance with some embodiments of the disclosure. The wireless communication system 100 may be a wireless communication system, such as 5G New Radio (NR), beyond 5G, Industrial Internet of Things (IIoT) and/or any other similar wireless communication system. As shown in FIG. 1, a mobile terminal 110 and a network 120 are communicatively connected through a radio access network. The network 120 may include a core network part and one or more base stations for serving the mobile terminal 110. In a case of 5G NR system, the mobile terminal 110 is also referred to as User Equipment (UE), the core network part in the network 120 is also referred to as 5G Core (5GC) Network or 4G Evolved Packet Core (EPC) supporting 5G functionalities, the base stations in the network 120 are also called as Next Generation NodeBs (gNBs), Evolved Universal Terrestrial Radio Access (E-UTRA) gNBs (en-gNBs) or next generation eNodeBs (ng-eNBs), and the radio access network may be referred to as Next Generation Radio Access Network (NG-RAN) or Evolved Universal Terrestrial Radio Access Network (E-UTRAN) supporting 5G functionalities.

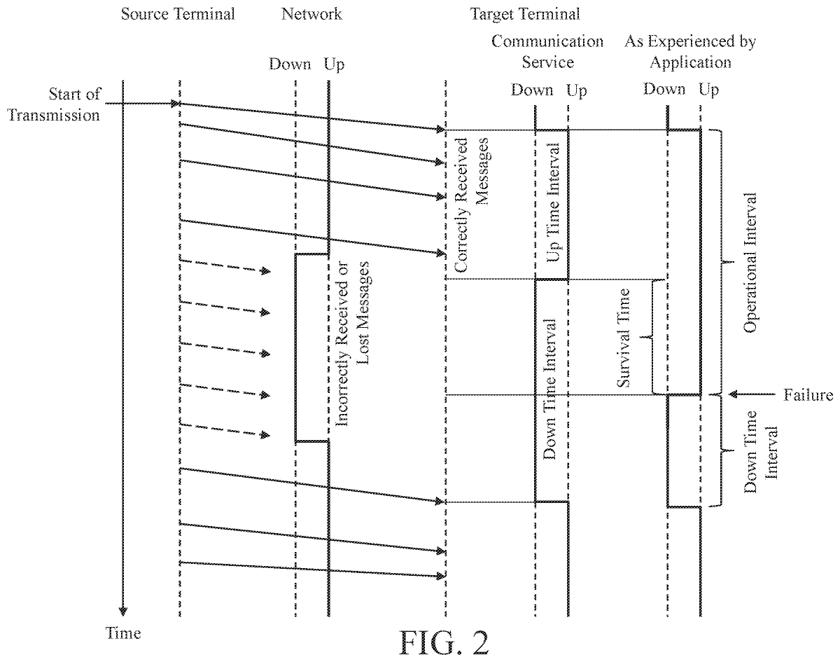

FIG. 2 illustratively shows an example of message transmissions from a source terminal to a target terminal through a network. The source terminal and the target terminal may be different terminals each similar to the mobile terminal 110 in FIG. 1, and the network may be the network 120 in FIG. 1. When the network is in an up state and runs normally, and the messages from the source terminal are correctly received by the target terminal with a running application. The communication service of the target terminal is also in an up state from the point of view of the running application. In a condition where the network transits into a down state (e.g. due to no longer supporting end-to-end transmissions of the messages from the source terminal to the target terminal according to the negotiated communication requirements), the messages from the source terminal would be lost or could not be correctly received by the target terminal. Once sensing the absence of expected messages, the application on the target terminal still waits for a survival time before it determines the communication service to be unavailable. The survival time may be expressed as a period or, especially with cyclic traffic, as maximum number of consecutive incorrectly received or lost messages. If the communication service receives messages from the source terminal before the survival time is exceeded, the application may stop the survival time, and the service is not interrupted. Otherwise, if the survival time is exceeded, the application transits the status of the communication service into a down state. The application may take a particular action for handling such situations of unavailable communication services. For instance, the application will commence an emergency shutdown. It is noted that the particular action does not imply that the target application is shut off. Rather, the application on the target terminal still listens to incoming packets, or may try to send messages to the source application on the source terminal. Once the network transits back into the up state, the communication service state as perceived by the application of the target terminal changes to the up state, and is thus again perceived as available. However, for the example shown in FIG. 2, the service is interrupted after the survival time is exceeded and before the communication service of the target terminal changes to the up state.

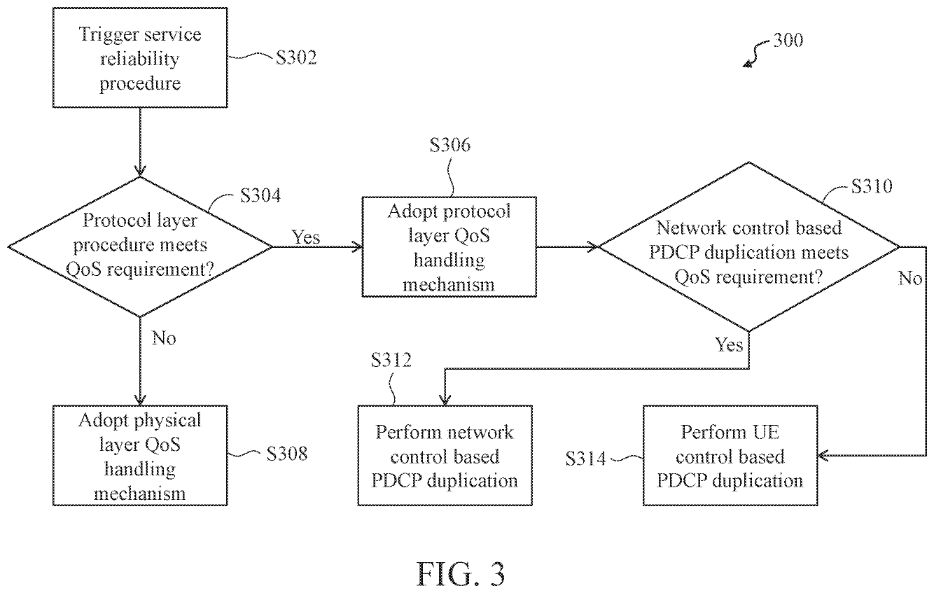

FIG. 3 is a flowchart illustrating a method 300 of a wireless communication system for enhancing QoS in order to avoid service interruptions due to survival time exceeded in accordance with some embodiments of the disclosure. In Step S302, a service reliability procedure is triggered in response to a first network condition. The first network condition may be, for example, an incorrect packet or a number of consecutive incorrect packets received by the network, or a packet is lost or a number of consecutive packets are lost and not received by the network. The service reliability procedure may be triggered by sending a radio resource control (RRC) message from the mobile terminal to the network.

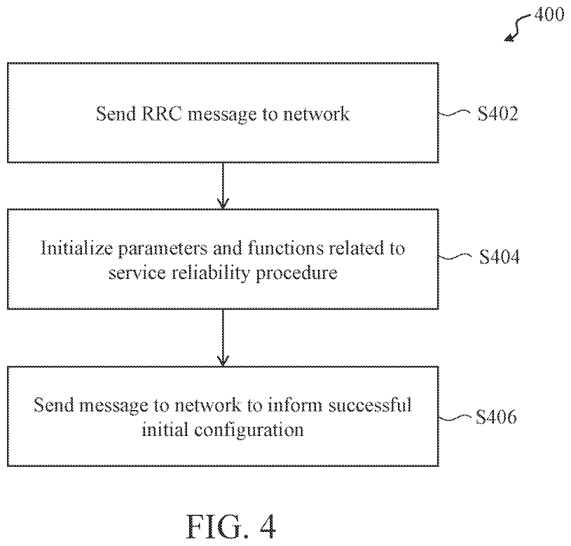

FIG. 4 is a flowchart illustrating a method 300 of an initial configuration at the mobile terminal for the service reliability procedure in accordance with some embodiments of the disclosure. In Step S402, the mobile terminal sends an RRC message to the network for indicating that the mobile terminal supports a QoS requirement. The RRC message may be an RRC setup message with UE capability information, an RRC resume message with UE capability information, an RRC reconfiguration message with UE capability information, an RRC UE capability information message, an RRC UL information transfer message, or the like. In some embodiments, the RRC message sent by the mobile terminal in Step S402 is a new RRC message other than those described above. In Step S404, the mobile terminal initializes the parameters and functions related to the service reliability procedure (such as supported QoS features related to survival time requirements, supported survival times, hybrid automatic repeat and request (HARQ) capabilities, PDCP duplication capabilities, scheduling related parameters, UE physical layer capabilities, and/or the like) to support the QoS requirement. The mobile terminal may obtain relative information from the network for the initiation of the parameters and functions if needed. The relative information may be, such as data radio bearer (DRB), configured grant (CG) or dynamic grant (DG) allocation for the mobile terminal, logical channel (LCH) configurations, radio link control (RLC) entity(ies), an initial value for indicating whether to activate PDCP duplications, physical layer configurations, media access control (MAC) layer configurations and/or RRC layer configurations, and/or the like. In Step S406, the mobile terminal sends a message to the network to inform that it successfully accomplishes the initial configuration. Steps S404 and S406 may be optional for some embodiments.

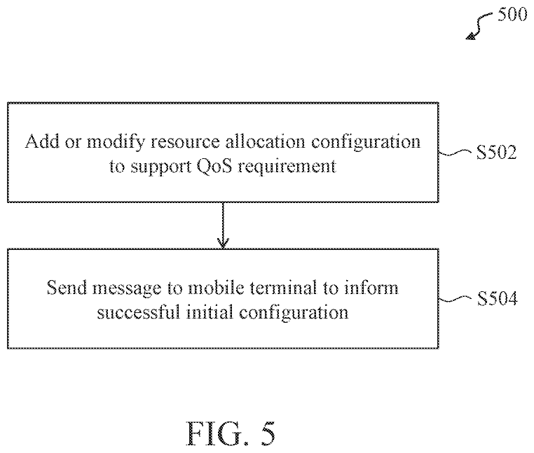

FIG. 5 is a flowchart illustrating a method 500 of an initial configuration at the network for the service reliability procedure in accordance with some embodiments of the disclosure. In Step S502, the network adds a new resource allocation configuration or modifies the existing resource allocation configuration to support the QoS requirement in response to the RRC message. The network may add a new resource allocation configuration or modify the existing resource allocation configuration in response to the RRC message from the mobile terminal. In particular, if there exists a protocol data unit (PDU) session, the network modifies the existing resource allocation configuration for the PDU session; else, the network adds a new resource allocation configuration with a trigger policy, e.g. based on HARQ feedback conditions. The network may choose or setup candidate connection(s) to meet the QoS requirement, depending on the measured channel quality(ies), e.g. channel quality index (CQI), reference signal received power (RSRP), received signal strength indicator (RSSI) and/or the like, and/or based on the bit error rate (BER) and/or the block error rate (BLER). Also, the network may setup candidate CG resources or semi-persistent scheduling (SPS) resources depending on the QoS requirement, e.g. the survival time, to determine the relative parameters, such as periodicity, priority and/or the like. In Step S504, the network sends a message to the mobile terminal to inform that it successfully accomplishes the initial configuration. Step S504 may be optional for some embodiments.

Referring back to FIG. 3, in Step S304, the QoS requirement is used to determine whether to perform a protocol layer QoS handling mechanism or a physical layer QoS handling mechanism to enhance QoS between the network and the mobile terminal. The QoS requirement may be a survival time requirement which may be determined upon applications.

If the protocol layer procedure meets the QoS requirement, Step S306 is performed, in which the protocol layer QoS handling mechanism is adopted; otherwise, Step S308 is performed, in which the physical layer QoS handling mechanism is adopted. Following Step S306, in Step S310, the QoS requirement is used to determine whether to perform a network control based packet data convergence protocol (PDCP) duplication procedure or a user equipment (UE) control based PDCP duplication procedure. If the network control based PDCP duplication meets the QoS requirement, then Step S312 is performed, in which the network activates a network control based PDCP duplication procedure by sending a MAC control element (CE) to the mobile terminal for activating an RLC entity. The MAC CE may be used for indicating to support the QoS requirement. Otherwise, Step S314 is performed, in which the mobile terminal starts a UE control based PDCP duplication procedure by activating an RLC entity.

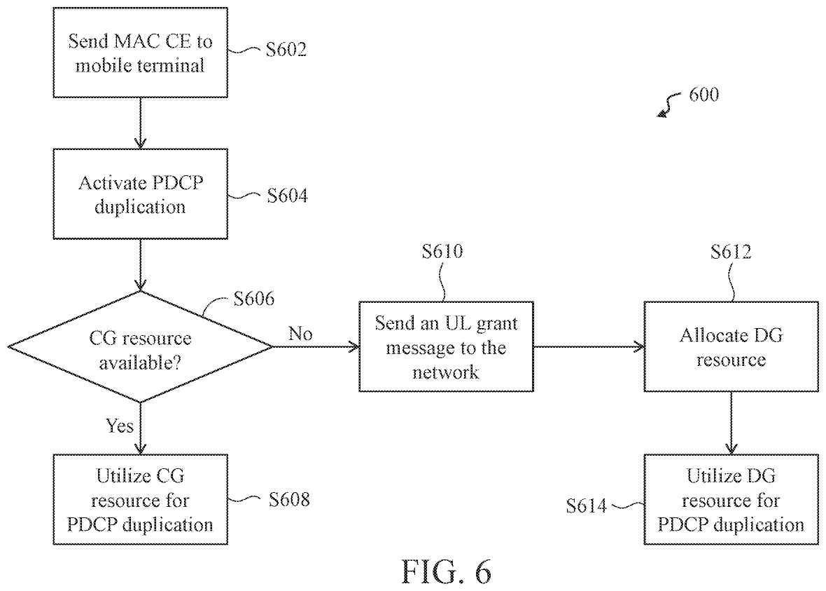

FIG. 6 is a flowchart illustrating a method 500 of a network control based PDCP duplication procedure in accordance with some embodiments of the disclosure. In Step S602, the network sends a MAC CE to the mobile terminal to activate a specific RLC entity or plural specific RLC entities for specific uplink (UL) data packets that belong to a DRB. In Step S604, the mobile terminal activates a PDCP duplication for the DRB. In Step S606, the mobile terminal determines whether a nearby allocated CG resource is available for use within the QoS requirement. If yes, then Step S608 is performed, in which the CG resource allocated nearby the mobile terminal is utilized to perform a PDCP retransmission for the specific UL data packets for the DRB. Otherwise, Step S610 is performed, in which the mobile terminal sends an UL grant message to the network to ask for a DG resource to perform a PDCP retransmission or transmission. In Step S612, in response to the UL grant message, the network allocates a DG resource toward the mobile terminal. Following Step S612, in Step S614, the mobile terminal utilizes the DG resource to perform a PDCP retransmission for the specific UL data packets for the DRB. Also, the CG or DG resource for use within the QoS requirement can also be used to perform a new transmission. In addition, the network can also enhance the downlink reliability by using available SPS resource or allocate new SPS resource for use within the QoS requirement to perform retransmission or transmission.

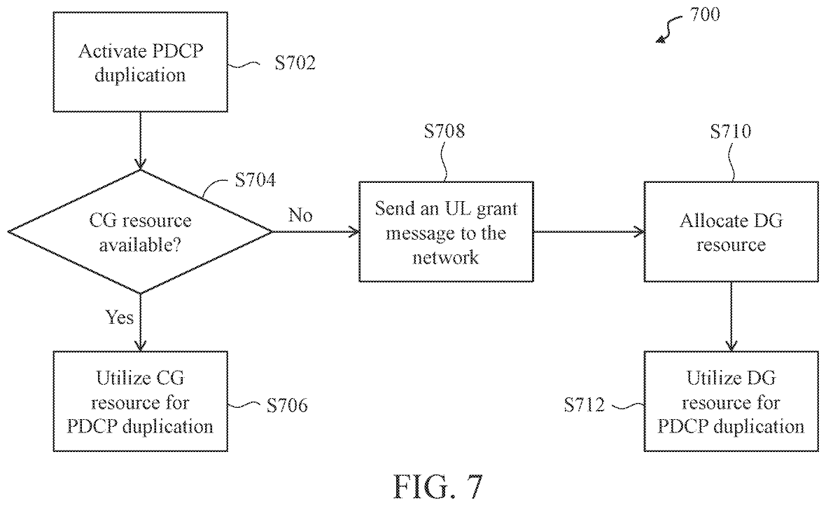

FIG. 7 is a flowchart illustrating a method 700 of a UE control based PDCP duplication procedure in accordance with some embodiments of the disclosure. In Step S702, the mobile terminal activates a PDCP duplication for the DRB. In Step S704, the mobile terminal determines whether a nearby allocated CG resource is available for use within the QoS requirement. If yes, then Step S706 is performed, in which the CG resource allocated nearby the mobile terminal is utilized to perform a PDCP retransmission for the specific UL data packets for the DRB. Otherwise, Step S708 is performed, in which the mobile terminal sends an UL grant message to the network to ask for a DG resource to perform a PDCP retransmission. In Step S710, in response to the UL grant message, the network allocates a DG resource toward the mobile terminal. Following Step S710, in Step S712, the mobile terminal utilizes the DG resource to perform a PDCP retransmission for the specific UL data packets for the DRB. In addition, the mobile terminal can also use CG or DG resource for use within the QoS requirement to perform a new transmission.

For the physical layer QoS handling mechanism, the transmission reliability may be improved by enhancing physical layer configurations at the mobile terminal and/or the network. In some embodiments, the physical layer QoS handling mechanism may be performed by applying physical layer repetition to retransmit or transmit a data packet. The physical layer repetition may include CG physical uplink shared channel (PUSCH) repetition, DG PUSCH repetition, resource block (RB) repetition, and/or another suitable repetition.

In some embodiments, the physical layer QoS handling mechanism may be performed by modifying a modulation and coding scheme (MCS) indication to retransmit or transmit a data packet, e.g., by downgrading the MCS to reduce the BER and/or the BLER.

In some embodiments, the physical layer QoS handling mechanism may be performed by performing Bandwidth Part (BWP) switching (e.g. allowing to switch to different BWPs) and/or beam sweeping on the mobile terminal and/or the network to retransmit or transmit data packets.

In some embodiments, the physical layer QoS handling mechanism may be performed by utilizing frequency hopping, multi-input multi-output (MIMO), non-orthogonal multiple access (NOMA), or uplink preemption to retransmit or transmit data packets with high priority according to the type of the wireless communication system and the capabilities of the mobile terminal and/or the network.

The wireless communication system may introduce a new QoS parameter for a new MAC CE or an existing MAC CE. The new MAC CE may be extended based on CG/SPS configurations MAC CE or PDCP duplication MAC CE. In addition, the wireless communication system may introduce a MAC Protocol Data Unit (PDU) with a new extended logical channel ID (eLCID) value for a Downlink Shared Channel (DL-SCH) and/or an uplink shared channel (UL-SCH) for supporting activation and deactivation of the service reliability procedure.

The wireless communication system may introduce a hybrid automatic repeat request (HARQ) process ID to enhance the HARQ feedback procedure to meet the QoS requirement. The enhanced HARQ feedback procedure may be performed in the physical layer to support (e.g. start and/or stop or measure) HARQ processes, or may be performed an upper layer (e.g. MAC layer, RLC layer or PDCP layer) to support (e.g. start and/or stop or measure) acknowledgement/negative-acknowledgement (ACK/NACK) processes. The base station may perform RRC configurations for the mobile terminal by exchange RRC messages with the mobile terminal for activating the service reliability procedure. Moreover, the core network in the network may perform core network configurations for the mobile terminal by exchange non-access stratum (NAS) messages with the mobile terminal for activating the service reliability procedure. In the network, the base station may exchange messages with the core network for activating the service reliability procedure.

The wireless communication system may introduce a new timer (e.g., a RRC timer) associated with the QoS requirement for a duration of transmission and/or retransmission. The new timer may be set to handle packet transmissions during the service reliability procedure.

The wireless communication system may introduce a new priority indicator to handle prioritization between the specific data packets and the other packets in the MAC layer and/or the physical layer. The new priority indicator may be set at the mobile terminal or the network to configure transmission priorities during the service reliability procedure.

The wireless communication system may introduce a new periodicity value or plural new periodicity values associated with the QoS requirement for transmission and/or retransmission periodicity. The new periodicity value(s) may be set at the mobile terminal or the network to handle packet transmissions and/or retransmissions during the service reliability procedure.

The wireless communication system may introduce new UE capability information for notifying support of the QoS requirement. The new UE capability information may be configured at the mobile terminal to support the QoS requirement during the service reliability procedure.

The wireless communication system may introduce a new transmission time interval (TTI), a new periodicity or a new priority or a new indicator for enabling physical layer repetition and/or MCS for the QoS requirement. The new TTI may be shorter than the original TTIs, the periodicity may be shorter than the original periodicities, the new priority may be higher than the original priorities, and the new indicator may be used to enable physical layer repetition and/or MCS for specific data packets. The new TTI, the new periodicity, the new priority and/or the new indicator may be applied for packet transmissions during the service reliability procedure.

The PDCP duplication may be stopped in response to a second network condition. The second network condition may be any condition in which the PDCP duplication can be stopped, e.g., a retransmission packet or a number of consecutive correct retransmission packets is/are correctly received, a retransmission packet or a number of consecutive retransmission packets is/are all received according to the HARQ feedback conditions, or the next new transmission packet or a number of consecutive transmission packets is/are received. The PDCP duplication may be stopped by the mobile terminal or the network. If a UE control based PDCP duplication stopping procedure is adopted, the mobile terminal may disable the activated RLC entity(ies) or disable packet duplication corresponding to the activated RLC entity(ies). The UE control based PDCP duplication stopping procedure may be performed without notifying the network. If a network control based PDCP duplication stopping procedure is adopted, the network sends a MAC CE to the mobile terminal for indicating which RLC entity(ies) is/are to be disabled, and then the mobile terminal disables the RLC entity(ies) or disable packet duplication corresponding to the RLC entity(ies) accordingly.

The PDCP duplication may be deactivated by the network in response to a third network condition. The third network condition may be any condition in which the PDCP duplication can be deactivated, e.g., the QoS service is no longer required, the QoS service is not supported, or the PDCP duplication function is unavailable. The network may send an RRC message to the mobile terminal for deactivating the PDCP duplication.

In the wireless communication system according to the embodiments of the disclosure, a handling mechanism similar to intra-UE prioritization is applied to meet the QoS requirement for new packets with a higher priority or the highest priority. When detecting transmission error(s), the mobile terminal or the network enables the functionality of QoS requirement support. The mobile terminal may duplicate the PDUs of the lost packets and performs an autonomous retransmission or a new transmission with the higher or highest propriety for the packets. The mobile terminal may select available allocated CG resource(s) to send the packets. Alternatively, the mobile terminal may issue an prioritized UL grant message and selects DG resource(s) to send packets, or else may utilize the DG resource(s) indicated by the network to send packets. The duplication may be performed for different RLC entities, for specific packets and/or both.

Similarly, the mobile terminal may duplicate the PDUs of the lost packets and performs an autonomous retransmission or a new transmission with the higher or highest priority for the packets. The network may select available allocated SPS resource(s) or allocate new SPS resource(s) to send packets. The duplication may be performed for different RLC entities, for specific packets and/or both.

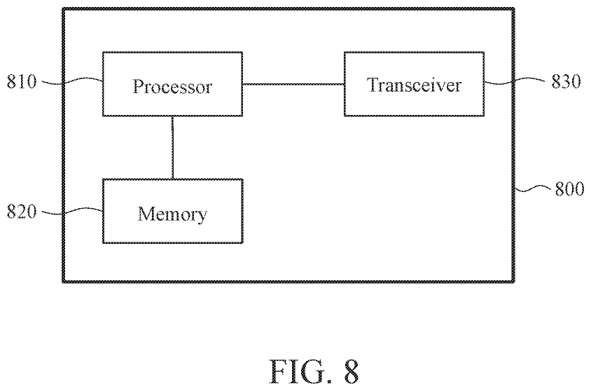

Referring to FIG. 8, which illustrates a block diagram of an apparatus 800 in accordance with some embodiments of the disclosure. Each of the mobile terminal 110 and a base station and/or another entity in the network 120 in FIG. 1 may have a block diagram similar to that of the apparatus. The apparatus 800 includes a processor 810, a memory 820 and a transceiver 830. The processor 810 may be, for example, a conventional processor, a digital signal processor (DSP), a microprocessor or an application-specific integrated circuit (ASIC), but is not limited thereto. The memory 820 may be any data storage device which may be read and executed by the processor 810. The memory 820 may be, for example, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk, a solid state disk (SSD), a flash memory or other data storage device suitable for storing a program code, but is not limited thereto. The transceiver 830 may be a radio transceiver for performing wireless communications with a remote entity based on the operation result of the processor 810. For example, if the apparatus 800 is the mobile terminal 110 in FIG. 1, the transceiver 830 performs wireless communications with a base station in the network 120; if the apparatus 800 is a base station in the network 120 in FIG. 1, the transceiver 830 performs wireless communications with the mobile terminal 110. The processors of the mobile terminal 110 and/or the base station in the network 120 may perform the methods 300, 400, 500, 600, 700 by executing the instructions stored in the memory thereof.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims.

What is claimed is:

1. A method for providing quality of service (QoS) in a wireless communication system, comprising:
triggering a service reliability procedure in response to a first network condition; and
determining whether to perform a protocol layer QoS handling mechanism or a physical layer QoS handling mechanism to enhance QoS between a network and a mobile terminal depending on a QoS requirement.

2. The method of claim 1, wherein performing the protocol layer QoS handling mechanism comprises:
activating, at the mobile terminal, a radio link control (RLC) entity for a packet data convergence protocol (PDCP) duplication; and
determining, by the mobile terminal, whether a configured grant (CG) resource allocated nearby the mobile terminal is available for use within the QoS requirement, and if yes, utilizing the CG resource to perform a PDCP retransmission or transmission; otherwise, sending an uplink (UL) grant message to the network to ask for a dynamic grant (DG) resource to perform a PDCP retransmission or transmission.

3. The method of claim 2, wherein performing the protocol layer QoS handling mechanism further comprises:
sending, by the network, a media access control (MAC) control element (CE) to the mobile terminal for activating the RLC entity in response to the first network condition.

4. The method of claim 2, further comprising:
stopping, by the mobile terminal, the PDCP duplication in response to a second network condition.

5. The method of claim 4, further comprising:
sending, by the network, a MAC CE to the mobile terminal for stopping the PDCP duplication in response to the second network condition.

6. The method of claim 2, wherein the network sends a radio resource control (RRC) message to the mobile terminal for deactivating the PDCP duplication in response to a third network condition.

7. The method of claim 1, wherein performing the physical layer QoS handling mechanism comprises applying physical layer repetition to retransmit or transmit a data packet.

8. The method of claim 7, wherein the physical layer repetition comprises at least one of CG physical uplink shared channel (PUSCH) repetition, DG PUSCH repetition or resource block (RB) repetition.

9. The method of claim 1, wherein performing the physical layer QoS handling mechanism comprises modifying a modulation and coding scheme (MCS) indication to retransmit or transmit a data packet.

10. The method of claim 1, wherein performing the physical layer QoS handling mechanism comprises performing Bandwidth Part (BWP) switching and/or beam sweeping on the mobile terminal and/or the network to retransmit or transmit a data packet.

11. The method of claim 1, wherein performing the physical layer QoS handling mechanism comprises utilizing frequency hopping, multi-input multi-output (MIMO), non-orthogonal multiple access (NOMA), or uplink preemption or transmit to retransmit or transmit a data packet for high priority transmission.

12. The method of claim 1, wherein the MAC CE is extended based on a CG/SPS configurations MAC CE or a PDCP duplication MAC CE for indicating to support the QoS requirement.

13. The method of claim 12, further comprising:
utilizing a MAC Protocol Data Unit (PDU) with an extended logical channel ID (eLCID) value for a Downlink Shared Channel (DL-SCH) or an uplink shared channel (UL-SCH) for supporting activation and deactivation of the service reliability procedure.

14. The method of claim 1, further comprising:
setting a timer to handle packet transmissions and/or re-transmission during the service reliability procedure.

15. The method of claim 1, further comprising:
setting a priority indicator to configure transmission priorities during the service reliability procedure.

16. The method of claim 1, further comprising:
setting a periodicity value to handle packet transmissions during the service reliability procedure.

17. The method of claim 1, further comprising:
configuring user equipment (UE) capability information to support the QoS requirement during the service reliability procedure.

18. The method of claim 1, further comprising:
adjusting a transmission time interval (TTI), a periodicity or a priority, or enabling physical layer repetition and/or MCS for packet transmissions during the service reliability procedure.

19. The method of claim 1, wherein triggering the service reliability procedure comprises:
sending, from the mobile terminal, an RRC message to the network for indicating that the mobile terminal supports the QoS requirement; and
adding or modifying, at the network, a resource allocation configuration to support the QoS requirement.

20. The method of claim 19, wherein the RRC message is an RRC setup message with UE capability information, an RRC resume message with UE capability information, an RRC reconfiguration message with UE capability information, an RRC UE capability information message or an RRC UL information transfer message.
